(19) United States
(12) Patent Application Publication
(10) Pub. No.: US 2012/0012298 A1
(43) Pub. Date: Jan. 19, 2012

(54) Method and Appratus for Heating an Aqueous Mixture to Vaporization

(76) Inventors: Scott A. Taylor, Broken Arrow, OK (US); John R. Shaw, Tulsa, OK (US); Philip Childers, Tulsa, OK (US)

(21) Appl. No.: 12/838,473

(22) Filed: Jul. 18, 2010

(51) Int. Cl. G05D 16/00; F28F 13/12; F28F 1/36

(52) U.S. Cl. 165/281; 165/184; 165/104.34

(57) ABSTRACT

The present invention is generally directed toward an apparatus and method for the heating of an aqueous mixture to vaporization, more specifically toward the heating of dilution air through a dilution air heating coil that is placed within the path of exhaust gas. In a power plant utilizing an emissions reduction process, such as a selective catalytic reduction (SCR) process, or other type of process, to remove harmful components, such as nitrous oxide (NO.sub.x), from a stream of flue gas wherein the emission reduction process includes the injection of vaporized aqueous mixture into the stream of flue gas, the present invention comprises a dilution air heating coil being placed within the path of exhaust gas to heat dilution air that is then subsequently used in the vaporization of the ammonia.

### REFERENCE TO PENDING APPLICATIONS

This application does not claim the benefit of any pending patent application.

### REFERENCE TO MICROFICHE APPENDIX

This application is not referenced in any microfiche appendix.

### BACKGROUND OF THE INVENTION

The present invention is generally directed toward an apparatus and method for vaporizing an aqueous ammonia mixture. More specifically, the present invention is directed toward an apparatus and method for heating of dilution air prior to the introduction thereof into a vaporization process.

One of the byproducts of gas turbine engines used in power plants is exhaust gas, commonly known as flue gas, containing components which are harmful to the atmosphere such as oxides of nitrogen, (NO.sub.x). To prevent harm to the atmosphere and to the power plant itself, the levels of these harmful components must be controlled. Accordingly, various methods and processes have been developed for the reduction of these harmful components. A principal process for the removal of NO.sub.x from the flue gas is the injection of a reducing agent such as ammonia or any of a number of other known reducing agents. A common method is the selective catalytic reduction (SCR) process which involves the injection of ammonia (NH3) in the flue gas and then passing the flue gas over a catalyst. SCR processes are based on the reaction of NO.sub.x with ammonia in the presence of a catalyst to form nitrogen and water. These methods are effective within a flue gas temperature window.

One traditional method of injecting into the flue gas stream uses an external ammonia vaporization system in which liquid ammonia, in an aqueous mixture, is first vaporized in a vaporizer and then routed to a distribution grid network for subsequent injection into the flue gas stream at a location upstream of an SCR reactor. The aqueous mixture is a mixture of combination of ammonia and water.

Areas of concern regarding the SCR process include ammonia breakthrough and a defined operating temperature window. To address these concerns, it has been discovered that the aqueous mixture which has been heated to an operational temperature sufficient to cause vaporization, allows the SCR process to function.

The aqueous mixture is vaporized in a vaporizer, prior to its introduction into the flue gas stream via the distribution grid network. If the aqueous mixture is introduced into the distribution grid network in a liquid state and not in a vaporized state, it will not be property effective. It is, therefore, critical the vaporizer have the ability to vaporize the aqueous mixture.

The prior art typically heats the vaporization chamber through a convection process which uses a diffuser fan to blow dilution air into the vaporization chamber. This process is very time consuming and costly. Typically, the convection process must first heat the air, usually through the use of an electric heater, prior to its introduction into the vaporizer. This takes time and adds additional operating costs. Accordingly, there is a need for a system to provide for a more efficient and effective heating of dilution air prior to its introduction into a vaporizer.

### SUMMARY OF THE INVENTION

The present invention satisfies the needs discussed above. The present invention is generally directed toward an apparatus and method for the heating of vaporized aqueous mixture, more specifically toward the heating of dilution air through a dilution air heating coil that is placed within the path of flue gas.

In a power plant utilizing a process to remove components which are harmful to the atmosphere such as oxides of nitrogen, (NO.sub.x) from a stream of flue gas wherein the process includes the utilization of a vaporization apparatus to vaporize an aqueous mixture and then subsequent injection of that vaporized aqueous mixture into the stream of flue gas, one aspect of the present invention comprises a dilution air coil assembly being located in the stream of flue gas to facilitate the heating of dilution air prior to its utilization in a subsequent process to vaporize the aqueous mixture containing, in part, ammonia.

By placing the dilution air coil assembly in the stream of flue gas, as the dilution air passes through the assembly, the heat of the flue gas heats the dilution air. This allows for the dilution air to become heated without the need for additional and separate heating devices, such as electric air heaters, etc.

In the power plant described above, yet another aspect of the present invention comprises a dilution air coil assembly having an inlet header assembly, an outlet header assembly and a plurality of heat exchange tubes in communication and between said inlet header assembly and outlet header assembly. The dilution air coil header assembly has an inlet for receiving the ambient dilution air and an outlet for providing the heated dilution air to the vaporization apparatus.

In the power plant described above, yet another aspect of the present invention comprises an aqueous mixture of ammonia in the range of less than 30% by volume and the balance being water.

In the power plant described above, another aspect of the present invention comprises an inlet assembly having one or more dilution air fans in communication with ambient air inlet tubing to provide ambient air to the dilution air coil assembly.

In the power plant described above, yet another aspect of the present invention comprises an outlet assembly having heated air inlet tubing in communication with the outlet of the dilution air coil assembly provide heated dilution air to the vaporization apparatus. The inlet or outlet assembly can also include one or more pressure flow elements for monitoring the heated dilution air flow and one or more control valves for controlling the heated dilution air flow rate.

Upon reading the included description, various alternative embodiments will become obvious to those skilled in the art. These embodiments are to be considered within the scope and spirit of the subject invention, which is only limited by the claims which follow and their equivalents.

### BRIEF DESCRIPTION OF THE DRAWINGS

FIG. 1 is a schematic view of an embodiment of the inventive apparatus to vaporize an aqueous mixture described herein.

FIG. 2 is a front view of an embodiment of the dilution air heating coil contained with the inventive apparatus to vaporize an aqueous mixture as set out in FIG. 1.

FIG. 3 is a flow diagram of an embodiment of the inventive method to vaporize an aqueous mixture described herein.

### DESCRIPTION OF THE PREFERRED EMBODIMENTS

The present invention is generally directed toward an apparatus and method for the heating of vaporized aqueous mixture, more specifically toward the heating of dilution air through a dilution air heating coil that is placed within the path of exhaust gas.

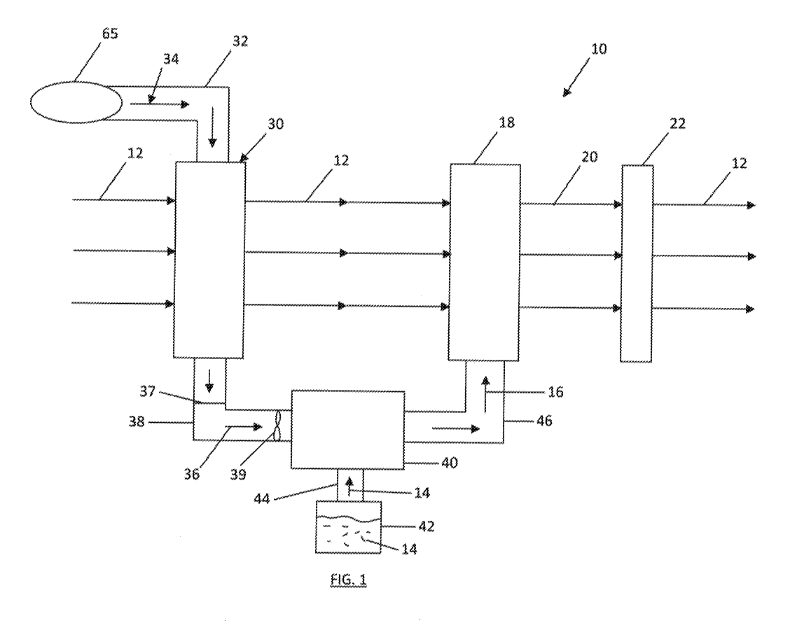

As illustrated in FIG. 1, a schematic of an embodiment of the inventive dilution air heating coil assembly 10 to heat dilution air that is to be used to vaporize an aqueous mixture is shown. The aqueous mixture can be in form of ammonia, but other similar mixtures can be utilized. The dilution air heating coil assembly 10 is part of a power plant which utilizes a selective catalytic reduction (SCR) process to remove components which are harmful to the atmosphere such as oxides of nitrogen (NOx) from a stream of flue gas 12. The use of the SCR process is not limiting but is merely illustrative. This process involves introducing an aqueous mixture in a vaporized state 16 and containing, in part, ammonia into the stream of flue gas 12 having atmospherically harmful components through a distribution grid network 18. The flue gas/vaporized mixture flow 20 then passing over a catalyst 22. The resulting flow 24 has a reduced amount of atmospherically harmful components therein.

Dilution air heating coil assembly 10 is shown to include a dilution air heating coil 30 being located within the stream of flue gas 12. Dilution air heating coil 30 additionally has an ambient dilution air inflow 32 for receiving ambient dilution air 34 from a dilution air fan 36. The ambient dilution air 34 passes through the dilution air heating coil 30. Due to the stream of flue gas 12 passing over the dilution air heating coil 30, the ambient dilution air 34 heats up becoming heated dilution air 36. A heated dilution air outflow 38 allows heated dilution air 36 to leave the dilution air heating coil 30 and be received within a vaporizer 40. The flow of heated dilution air 36 can be monitored by monitoring element 37 and be controlled by a control valve 39, such as a butterfly valve.

Inside the vaporizer 40, heated dilution air 36 mixes with an aqueous mixture in a liquid state 14 that was received from a storage unit 42 through an aqueous mixture inflow 44 creating the aqueous mixture in a vaporized state 16. A vaporized aqueous mixture outflow 46 provides the aqueous mixture in a vaporized and diluted state 16 to the distribution grid network 18 for mixing with the flue gas 12.

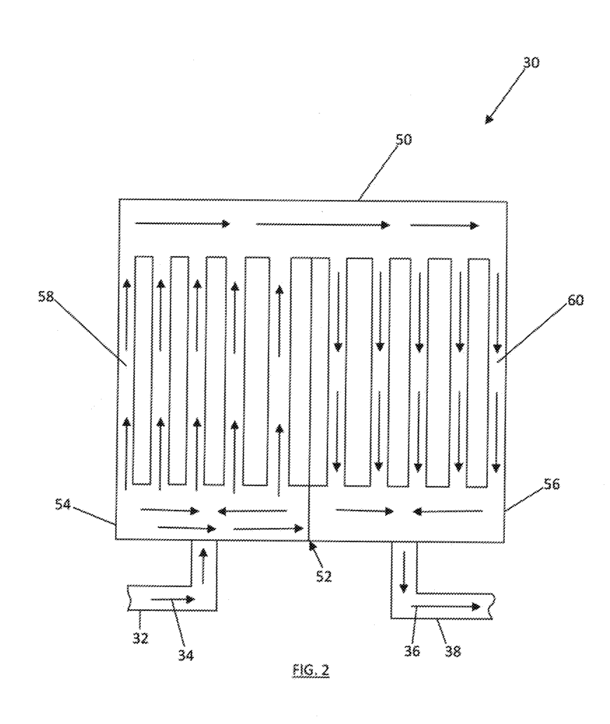

Illustrated in FIG. 2 is an embodiment 30 of the dilution air heating coil of the present invention. Embodiment 30 is an air to air heat exchanger. When it is placed within the stream of flue gas 12, the heat from the flue gas 12 provides the heat source to heat the dilution air 34 that is passing through. Embodiment 30 comprises an upper header 50 and a lower header 52 subdivided into an inflow lower header 54 and an outflow lower header 56. Inflow heat exchange tubes 58 extend between upper header 50 and inflow lower header 54. Additionally, ambient dilution air inflow 32 is in communication with inflow lower header 54. Likewise, outflow exchange tubes 60 extend between upper header 50 and outflow lower header 56, and heated dilution air outflow 38 is in communication with outflow lower header 56.

In operation, dilution air fan 65 forces ambient dilution air 34 through ambient dilution air inflow 32 and inflow lower header 54 and into inflow heat exchange tubes 58. The dilution air 34 then passes through upper header 50 and into outflow heat exchange tubes 60. It then passes through outflow lower header 56 and exits the dilution air heating coil 30 through heated dilution air outflow 38. The stream of flue gas 12 heats the tubes 58 and 60, causing ambient dilution air 34 contained within inflow and outflow heat exchange tubes 58 and 60 to also become heated.

By utilizing the heat from the steam of flue gas 12, the cost for heating dilution air is reduced. Further, the energy requirements are also reduced allowing the process to be environmentally friendly.

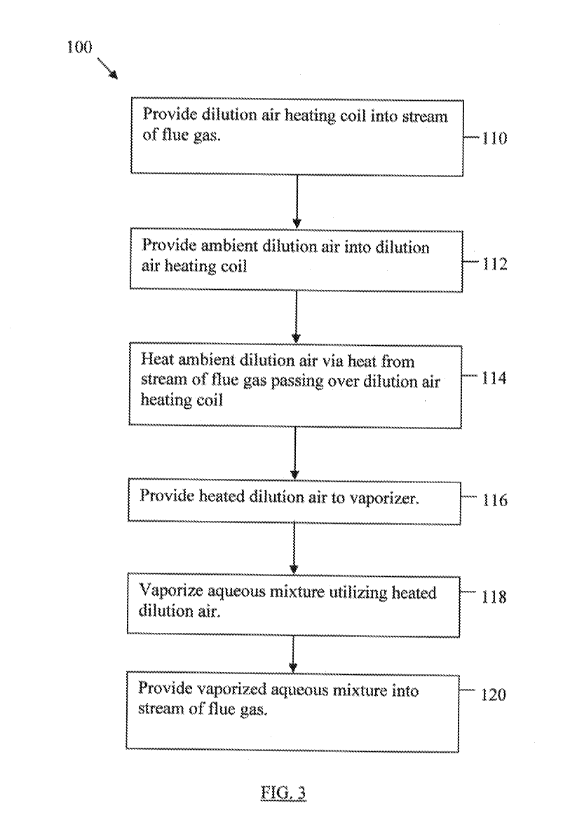

Illustrated in FIG. 3 is a flow diagram of an embodiment 100 of the method to heat dilution air comprising the steps of providing a dilution air heating coil into the stream of flue gas 110 and then providing ambient dilution air into the dilution air heating coil 112. The ambient air is then heated due to the passing of the stream of flue gas across the dilution air heating coil 114. The heated dilution air is then provided to a vaporizer 116 where the heated dilution air mixes with an aqueous mixture vaporizing this mixture 118. The vaporized aqueous mixture is then provided into the same stream of flue gas that originally heated the dilution air 120.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification, but is to be limited only by the scope of the attached claims, including the full range of equivalency to which each element thereof is entitled.

We claim:

1. A dilution air assembly utilized in a power plant utilizing a process to remove components harmful to the atmosphere from a stream of flue gas, wherein said process includes the vaporization of an aqueous mixture in a vaporizer apparatus and then the injection of said vaporized aqueous mixture in the stream of flue gas by way of a distribution grid, said dilution air assembly comprising:
a dilution air coil assembly being located in the stream of flue gas, said dilution air coil assembly having an inlet for receiving ambient dilution air and an outlet for providing heated dilution air to said vaporizer apparatus;
an inlet assembly in communication with said inlet of said dilution air coil assembly for providing said ambient dilution air into said dilution air coil assembly; and
an outlet assembly in communication with said outlet of said dilution air coil assembly for providing said heated dilution air into said vaporizer assembly.

2. The dilution air coil assembly according to claim 1 wherein said aqueous mixture comprises ammonia in the range of less than 30% by volume and the balance being water.

3. The dilution air coil assembly according to claim 1 wherein said inlet assembly comprises one or more dilution air fans and ambient air inlet tubing in communication with said one or more dilution air fans and said inlet of said dilution air coil assembly.

4. The dilution air coil assembly according to claim 3 wherein said inlet assembly further comprises one or more pressure flow elements for monitoring the heated dilution air flow.

5. The dilution air coil assembly according to claim 3 wherein said inlet assembly further comprises one or more pressure flow elements for monitoring the heated dilution air flow.

6. The dilution air coil assembly according to claim 1 wherein said outlet assembly comprises heated air inlet tubing in communication with said outlet of said dilution air coil assembly and said vaporizer apparatus.

7. The dilution air coil assembly according to claim 6 wherein said outlet assembly further comprises one or more pressure flow elements for monitoring the heated dilution air flow.

8. The dilution air coil assembly according to claim 6 wherein said outlet assembly further comprises one or more control valves for controlling the heated dilution air flow rate.

9. The dilution air coil assembly according to claim 1 wherein dilution air coil assembly comprises an upper header assembly, a lower header assembly having said inlet and said outlet and a plurality of heat exchange tubes in communication and between said inlet header assembly and outlet header assembly.

10. In a power plant utilizing a process to remove components harmful to the atmosphere from a stream of flue gas, wherein said process includes the vaporization of an aqueous mixture in a flue gas by way of a distribution grid, a method for heat dilution air comprising the steps of:
providing a dilution air heating coil into said stream of flue gas, wherein said stream of flue gas providing heat to said dilution air heating coil;
providing dilution air into said dilution air heating coil, wherein said dilution air is heated;
providing said heated dilution air to said vaporizer apparatus, wherein said heated dilution air mixes with said aqueous mixture creating said vaporized aqueous mixture; and
providing said vaporized aqueous mixture into said stream of flue gas.

11. The method of claim 10 wherein said aqueous mixture comprises ammonia in the range of less than 30% by volume and the balance being water.
